(19) United States
(12) Patent Application Publication
(10) Pub. No.: US 2020/0251709 A1
(43) Pub. Date: Aug. 6, 2020

(54) Porous Composite Separator and Manufacturing Method Therefor

(71) Applicants: SK Innovation Co., Ltd., Seoul (KR); SK IE Technology Co., Ltd., Seoul (KR)

(72) Inventors: Cholho Lee, Daejeon (KR); Minsang Park, Daejeon (KR); Hyejin Lee, Daejeon (KR); Suji Lee, Daejeon (KR)

(21) Appl. No.: 16/640,427

(22) PCT Filed: Aug. 21, 2018
(86) PCT No.: PCT/KR2018/009558

§ 371 Date: Feb. 20, 2020

(30) Foreign Application Priority Data
Aug. 25, 2017 (KR) 10-2017-0107695

(51) Int. Cl. H01M 2/16; H01M 2/14

(52) U.S. Cl. CPC H01M 2/1606; H01M 2/1653; H01M 2/145

(57) ABSTRACT

The present invention relates to a porous composite separator filled with a high heat-resistant porous polymer having nano-sized pores in addition to micro-sized wide pores formed among fibers of a porous support formed of the fibers, and to a manufacturing method therefor. The porous composite separator of the present invention has excellent strength, resistance to electrolyte swelling, and heat resistance and a minimized thickness change, and thus can provide a thin film type separator.

### TECHNICAL FIELD

The present invention relates to a porous composite separator in which micro-sized large pores formed between fibers of a porous support formed of fibers are filled with a high heat-resistant porous polymer having nano-sized pores, and a method of producing the same.

### BACKGROUND ART

In recent years, interest in energy storage technology has been rapidly increased, and a study of an electrochemical device which is used in mobile phones, laptops, electric vehicles, and the like has also been rapidly increased. More specifically, there have been studies of a lithium secondary battery, and among them, there is a study of a separator which is one of the important constituent elements determining the characteristics of the battery. Since a separator is impregnated with an electrolyte and functions as a passage of lithium ions, it has a great influence on the physical properties of the electrochemical device.

For reduced production costs of the separator, there was a study of using a porous nonwoven fabric, but since the nonwoven fabric has micro-sized large pores, a leakage current may occur during operation of the electrochemical device, which leads insulation deterioration of the separator.

In order to solve the problem, there have been many studies of laminating fine layers densely using electrospinning, but the productivity is low, resulting in loss of the merit of using a low-cost nonwoven fabric.

Meanwhile, there has been a study of forming pores in a polymer having better heat resistance than polyethylene or polypropylene which are generally used and applying the polymer as a separator. Though the method has a merit that heat resistance of the separator to be obtained is excellent, the mechanical strength is low and a volume change due to swelling of an electrolyte solution is large.

The following studies of combining the merits of a nonwoven fabric and a high heat-resistant polymer have been attempted, but there is a problem in the practical use of the separator.

There has been a study of forming a polymer layer on one surface or both surfaces of a porous substrate layer formed of a nonwoven fabric; however, when the polymer layer is formed on the surface, an interface between the nonwoven fabric and the polymer layer may open, and though thinning of the separator was required for increasing the capacity of the electrochemical device, the thickness of the separator is increased by the thickness of a coating layer.

In addition, there has been a study of applying a slurry in which inorganic particles and a polymer binder are mixed on a nonwoven fabric, and the pores of the nonwoven fabric are filled with the slurry using suction to control a pore size of the nonwoven fabric, but there is a difficulty in controlling the pore size and the pores may be formed unevenly between suction portions and non-suction portions.

In addition, there has been a study of impregnating a nonwoven fabric with a pore inducing material and a polymer, and etching the pore inducing material with an etchant to form an interconnected pore structure, but the etchant is not evenly permeated to the inside, so that the pores may be increasingly unevenly formed from the surface layer to the inside of the nonwoven fabric. In addition, the physical properties of a nonwoven fabric or a polymer may be affected by an etchant.

### DISCLOSURE

### Technical Problem

An object of the present invention is to provide a porous composite separator having a less thermal shrinkage, excellent stability against an electrolyte solution, excellent mechanical physical properties, and excellent heat resistance.

Another object of the present invention is to provide a porous composite separator which does not have an interface opening between a porous matrix formed of fibers and a polymer matrix, may have a minimized increase in a separator thickness by filling micro-sized large pores of the porous matrix formed of fibers with a high heat-resistant polymer resin, and when applied to the separator of an electrochemical device, may be applied as multiple layers for the same volume, thereby improving a capacity and stability of an electrochemical device.

Still another object of the present invention is to provide a porous composite separator which may have pores evenly formed from a surface layer to the inside of the separator by forming nano-sized pores in a matrix formed of a high heat-resistant polymer resin by phase separation using a phase separating agent incompatible with the high heat-resistant polymer resin, and in which a pore size is easily adjusted by controlling a content of the phase separating agent and production method conditions.

### Technical Solution

In one general aspect, a porous composite separator includes: a porous support formed of fibers and a porous high heat-resistant polymer matrix filling space between the fibers, wherein a rate of thickness change according to the following Equation 1 is 70% or less:

Rate of thickness change (%)=(total thickness of porous composite separator−thickness of porous support)/thickness of porous support×100. [Equation 1]

In another general aspect, a method of producing a porous composite separator includes:
a) impregnating a porous support formed of fibers with a matrix composition in which a high heat-resistant polymer, a phase separating agent incompatible with the high heat-resistant polymer, and a solvent compatible with both the phase separating agent and the high heat-resistant polymer are mixed;
b) removing the solvent to induce phase separation of the phase separating agent and the high heat-resistant polymer; and
c) removing the phase separating agent to form a high heat-resistant porous polymer matrix.

### Advantageous Effects

In the separator according to the present invention, a high heat-resistant polymer matrix is formed between pores of a porous support, thereby minimizing a thickness change of the porous support, further improving heat resistance, and having nano-size pores evenly formed as a whole including in a thickness direction, and thus, the separator has an effect of further improving a capacity and stability when being applied to an electrochemical device.

In the present invention, micro-sized pores of a porous support formed of fibers, more specifically a porous support such as a fabric, a nonwoven fabric, and nanofiber web are filled with a heat-resistant polymer, and nano-sized pores are formed in the heat-resistant polymer, thereby further improving not only heat resistance but also stability against an electrolyte solution by a combination of a specific high heat-resistant polymer and a nonwoven fabric, and providing a separator of a thin film.

In addition, it is easy to adjust a pore size and distribution by the method of producing a separator of the present invention.

The porous composite separator of the present invention has excellent resistance to electrolyte solution swelling and excellent heat resistance, and minimized thickness change to provide a separator of a thin film.

### DESCRIPTION OF DRAWINGS

FIG. 1 is a photograph showing an exemplary embodiment of the porous composite separator of the present invention.

### BEST MODE

Hereinafter, the present invention will be described in more detail with reference to the exemplary embodiments and Examples including the accompanying drawings. However, the following exemplary embodiments and Examples are only a reference for describing the present invention in detail, and the present invention is not limited thereto, and may be implemented in various forms.

In addition, unless otherwise defined, all technical terms and scientific terms have the same meanings as those commonly understood by a person skilled in the art to which the present invention pertains. The terms used herein are only for effectively describing a certain exemplary embodiment, and are not intended to limit the present invention.

In addition, the singular form used in the specification and claims appended thereto may be intended to also include a plural form, unless otherwise indicated in the context.

An embodiment of the present invention is a porous composite separator includes: a porous support formed of fibers and a porous high heat-resistant polymer matrix filling space between the fibers, wherein a rate of thickness change according to the following Equation 1 70% or less:

Rate of thickness change (%)=(total thickness of porous composite separator−thickness of porous support)/thickness of porous support×100. [Equation 1]

In an exemplary embodiment of the present invention, the porous composite separator may have a thermal shrinkage of less than 15% in each of transverse and longitudinal directions, the thermal shrinkage being measured after allowing the porous composite separator to stand in an oven at 250° C. for an hour.

In an exemplary embodiment of the present invention, the thermal shrinkage may be less than 10%.

In an exemplary embodiment of the present invention, the thermal shrinkage may be less than 5%.

In an exemplary embodiment of the present invention, the porous composite separator may have a rate of size change of 5% or less in each of transverse and longitudinal directions, the rate of size change being measured after immersing the porous composite separator in an electrolyte solution for a week.

In an exemplary embodiment of the present invention, the rate of size change may be 3% or less in each of transverse and longitudinal directions.

In an exemplary embodiment of the present invention, the high heat-resistant porous polymer matrix may have pores formed by a phase separating agent incompatible with a high heat-resistant polymer.

In an exemplary embodiment of the present invention, 30% or more of a void volume inside the porous support may be occupied by the high heat-resistant porous polymer matrix.

In an exemplary embodiment of the present invention, a material of a polymer fiber forming the porous support may be selected from any one, a blend of two or more, or a copolymer of two or more selected from the group consisting of polyester, polyimide, polyamide, polysulfone, polyvinylidene fluoride, polyacrylonitrile, and polyolefin.

In an exemplary embodiment of the present invention, the high heat-resistant porous polymer matrix may have a porosity of 10 to 90%.

In an exemplary embodiment of the present invention, an average diameter of pores inside the high heat-resistant porous polymer matrix may be 1 μm or less.

In an exemplary embodiment of the present invention, the high heat-resistant porous polymer matrix may be formed of any one or two or more high heat-resistant polymers selected from the group consisting of polyimide, polyamide, aramid, polyamideimide, and polyparaphenylbenzobisoxazole.

Another embodiment of the present invention is an electrochemical device including a positive electrode, a negative electrode, and a separator interposed between the positive electrode and the negative electrode, wherein the separator includes the porous composite separator.

In an exemplary embodiment of the present invention, the electrochemical device may be a lithium secondary battery.

Another embodiment of the present invention is a method of producing a porous composite separator including:
a) impregnating a porous support formed of fibers with a matrix composition in which a high heat-resistant polymer, a phase separating agent incompatible with the high heat-resistant polymer, and a solvent compatible with both the phase separating agent and the high heat-resistant polymer are mixed;
b) removing the solvent to induce phase separation of the phase separating agent and the high heat-resistant polymer; and
c) removing the phase separating agent to form a high heat-resistant porous polymer matrix.

In an exemplary embodiment of the present invention, the solvent in step b) may be removed by heating, and the phase separating agent in step c) may be removed by heating or cleaning.

In an exemplary embodiment of the present invention, in step b) and step c), the phase separating agent and the solvent may be removed by immersion in an exchange solution having compatibility with the phase separating agent and the solvent.

In an exemplary embodiment of the present invention, a method of impregnating the matrix composition in step a) may be selected from the group consisting of dip coating, knife coating, roller coating, air knife coating, spray coating, brush coating, calender coating, and slot die coating.

Hereinafter, each constituent element of the present invention will be described in detail.

[Porous Composite Separator]

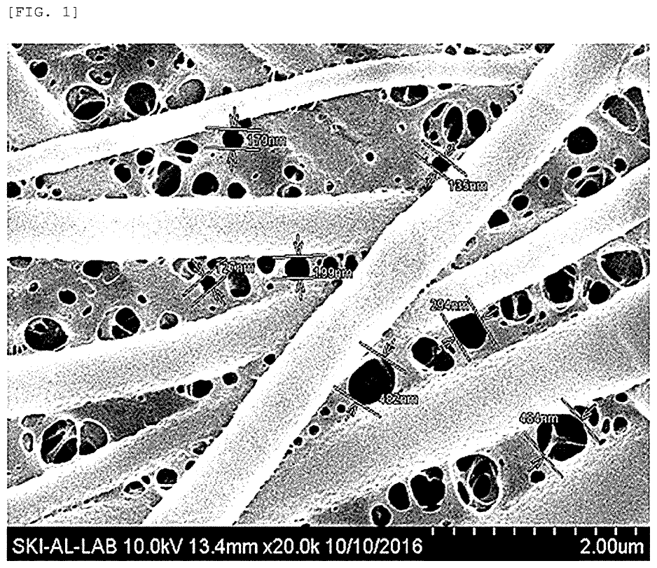

The porous composite separator of the present invention includes a porous support formed of fibers and a high heat-resistant porous polymer matrix filling space between the fibers forming the porous support, as shown in FIG. 1.

In an exemplary embodiment of the present invention, the porous support formed of fibers refers to a woven fabric, a nonwoven fabric, a nanofiber web, and the like. More preferably, the porous support may be formed of a nonwoven fabric, in terms of easy raw material supply and demand, mechanical strength, and low production costs, but the present invention is not limited thereto.

In an exemplary embodiment of the present invention, the nonwoven fabric is not limited as long as it is produced by a common production method, but may be produced by a wet laid method in which cut fibers are dispersed using a dispersing solvent and then the dispersing solvent is removed to produce the nonwoven fabric. In addition, the nonwoven fabric may have further improved mechanical strength by further including a step of heating and pressing the nonwoven fabric produced by a common wet laid method, so that regions where fibers forming the nonwoven fabric cross are physically combined by fusion.

In an exemplary embodiment of the present invention, the material of the polymer fiber forming the porous support may be any one, a blend of two or more, a copolymer of two or more, or the like, selected from the group consisting of polyester, polyimide, polyamide, polysulfone, polyvinylidene fluoride, polyacrylonitrile, and polyolefin, and polyester, and more specifically, polyethylene terephthalate and the like may be used due to excellent stability against an electrolyte solution, excellent mechanical strength, and easy impregnation possibility of space between fibers with the high heat-resistant polymer, but is not limited thereto.

In an exemplary embodiment of the present invention, the porous support may be formed of a polymer fiber having a diameter of 10 μm or less, preferably 5 μm or less, and more preferably 3 μm or less. More specifically, the polymer fiber may have a diameter of 1 to 10 μm, and within the range, the mechanical strength is excellent, and smaller and more even pores may be formed when using the porous support having the same thickness, which is thus preferred, but is not limited thereto.

In addition, it is preferred that an average void between fibers is 5 μm or less, and more specifically 1 to 5 μm, since it is advantageous for coating a matrix composition for forming a heat-resistant polymer matrix, while having excellent battery stability, but is not limited thereto.

In an exemplary embodiment of the present invention, the thickness of the porous support is not limited, but may be 22 μm or less, preferably 17 μm or less, and more preferably 12 μm or less, but is not limited thereto. Thinning of the separator is required for increasing a battery capacity, which is preferred since it is appropriate for providing a separator of a thin film required in the range, but is not limited thereto. More specifically, the thickness may be 1 to 22 μm, but is not limited thereto.

[High Heat-Resistant Porous Polymer Matrix]

In an exemplary embodiment of the present invention, the high heat-resistant porous polymer matrix is impregnated into the pores of the porous support so as to fill the micro-sized pores of the porous support and form nano-sized pores. That is, the polymer matrix has a plurality of nano-sized fine holes inside, has a structure in which fine holes are connected, and has permeability to gas or liquid.

The high heat-resistant porous polymer matrix of the present invention may be formed by preparing a matrix composition using a phase separating agent incompatible with a high heat-resistant polymer and a solvent which may dissolve the high heat-resistant polymer and the phase separating agent, immersing the porous support in the matrix composition or coating the porous support with the matrix composition so that the porous support is impregnated with the matrix composition, then removing the solvent to induce phase separation of the high heat-resistant polymer and the phase separating agent, and removing the phase separating agent after performing phase separation, so that pores are formed in places where the phase separating agent has existed.

In another exemplary embodiment of the present invention, the high heat-resistant porous polymer matrix of may be formed by preparing a matrix composition using a phase separating agent incompatible with a high heat-resistant polymer and a solvent which may dissolve the high heat-resistant polymer and the phase separating agent, immersing the porous support in the matrix composition or coating the porous support with the matrix composition so that the porous support is impregnated with the matrix composition, and then immersing the porous support in the solvent having compatibility with the phase separating agent and the solvent to remove the solvent and the phase separating agent, so that pores are formed in places where the phase separating agents has existed. Here, when the phase separating agent and the solvent are immersed in the solvent having compatibility with them, the solvent having higher compatibility is first removed by a difference in solvent compatibility to induce phase separation to form pores, and then the phase separating agent is removed to form pores.

In an exemplary embodiment of the present invention, the high heat-resistant porous polymer matrix is a polymer which is commonly known as a high heat-resistant polymer, and any polymer may be used without limitation as long as it has a melting temperature of 200° C. or higher. More preferably, it is preferred to use a resin having excellent stability to an electrolyte solution, excellent heat resistance, and excellent interface adhesion to the porous support. Specifically for example, polyimide, polyamide, aramid, polyamideimide, polyparaphenylbenzobisoxazole, and the like may be used from the above viewpoint, and may be used alone or in combination of two or more, but the present invention is not limited thereto.

More preferably, from the viewpoint of facilitating the control of pores intended in the present invention, polyimide and polyamideimide may be used, but the present invention is not limited thereto. The polyimide is a resin which is cured from a polyamic acid precursor by heat to be polymerized, and the phase separating agent incompatible with the polyamic acid precursor is used to remove the solvent in the course of heat treatment and to induce phase separation, thereby forming pores. Here, the size of pores and porosity may be controlled depending on the content of the phase separating agent and phase separation conditions.

In an exemplary embodiment of the present invention, when the high heat-resistant polymer is polyimide, polyamide, and polyamideimide, the phase separating agent means a material incompatible with the high heat-resistant polymer, that is, a material which is not mixed with the high heat-resistant polymer. In addition, a material which may be dissolved in a solvent dissolving the high heat-resistant polymer and has a different boiling point from the solvent is preferred, and more preferably, a material having a higher boiling point than the solvent may be used, and the material may satisfy the following Equation 2:

Melting point of high heat-resistant polymer>Boiling point of phase separating agent>Boiling point of solvent [Equation 2]

More specifically, a material having a boiling point difference of 5° C. or higher, and more preferably 20° C. or higher from the solvent is used as the phase separating agent, whereby phase separation with the high heat-resistant polymer may be induced without drying the phase separating agent together when heating the solvent for drying.

In addition, after the phase separation is completed, from the viewpoint of easily removing the phase separating agent from the high heat-resistant polymer, it is preferred to use a material which may be removed by drying at a melting point or a thermal decomposition temperature of the high heat-resistant polymer or lower, or may be removed by water, a solvent incompatible with the high heat-resistant polymer, or the like.

Here, by adjusting the drying time of the solvent and temperature raising conditions, the separation degree may be controlled and the size of pores and the porosity may be adjusted. For example, when the solvent is N-methyl-2-pyrrolidone, the solvent is removed at 100 to 150° C. to induce phase separation, and then the phase separating agent is removed while the temperature is gradually raised to 300° C., or the phase separating agent is removed by using a solvent dissolving only the phase separating agent. That is, the phase separating agent is removed by heating or washing, thereby forming the high heat-resistant porous polymer matrix in which pores are formed in portions where the phase separating agent has existed. The phase separating agent may be removed from polyimide by thermal decomposition or evaporation by heating. The washing may be immersion in a washing tank containing a solution for removing only the phase separating agent by dissolution, and water or a solvent is used alone or water is used in a mixture with alcohols having good compatibility with water, such as methanol, ethanol, and isopropyl alcohol.

In an exemplary embodiment of the present invention, as an example of the phase separating agent, ether-based solvents such as polyethylene glycol, tetraethylene glycol dimethyl ether, polyvinylpyrrolidone, diethylene glycol dimethyl ether, triethylene glycol dimethyl ether, diethylene glycol, and triethylene glycol may be used, and they may be used alone or in combination of two or more, but is not limited thereto.

In an exemplary embodiment of the present invention, the solvent which may dissolve both the high heat-resistant polymer and the phase separating agent may be a nitrogen-containing polar solvent. Though it is not limited the following, the solvent is more specifically for example, N-methyl-2-pyrrolidone, N,N-dimethylformamide, N,N-dimethylacetamide, tetramethyl urea, dimethylethylene urea, and the like, which may be used alone or in combination of two or more.

In an exemplary embodiment of the present invention, when the high heat-resistant polymer is polyparaphenylbenzobisoxazole, the phase separating agent may be a material which is incompatible with the high heat-resistant polymer, may be dissolved in the solvent dissolving the high heat-resistant polymer, and has a solubility difference from the solvent. Accordingly, a matrix composition in which the high heat-resistant polymer, the phase separating agent, and the solvent are mixed may be impregnated in the porous support, the porous support may be immersed in an exchange solution having compatibility with the phase separating agent and the solvent to sequentially remove the solvent and the phase separating agent. That is, the solvent having higher affinity with the exchange solution is first removed and phase separation is performed, and by removing the phase separating agent, pores may be formed.

In an exemplary embodiment of the present invention, when the high heat-resistant polymer is polyparaphenylbenzobisoxazole, the phase separating agent may be a fluoro-containing carboxylic acid such as trifluoroacetic acid, and may be used alone or in combination of two or more, but is not limited thereto. In addition, the solvent may be a protic strong acid such as polyphosphoric acid, methane sulfonic acid, and sulfuric acid, and may be used alone or in combination of two or more, but is not limited thereto.

In an exemplary embodiment of the present invention, when the high heat-resistant polymer is polyparaphenylenebenzobisoxazole, a mixing ratio of the solvent and the phase separating agent may be 1:1 or more, and more preferably 1:3 or more as a volume ratio.

In an exemplary embodiment of the present invention, when the high heat-resistant polymer is polyparaphenylenebenzobisoxazole, a solution of polyparaphenylenebenzobisoxazole, the solvent, and the phase separating agent may be prepared and impregnated into the porous support, and the impregnated material may be immersed in any one or a mixture of two or more selected from water, acetone, isopropyl alcohol, or the like to remove the solvent and the phase separating agent.

In an exemplary embodiment of the present invention, an average diameter of the pores in the high heat-resistant porous polymer matrix is not limited, but may be 1 μm or less, more specifically 0.01 to 1000 nm, preferably 0.1 to 500 nm, and more preferably 0.1 to 50 nm, a pore size and porosity may be controlled depending on the content of the phase separating agent and a phase separation process, and though the average diameter of the pores is not limited to the above range, ion conductivity may be controlled and an internal short circuit possibility of a battery by a contact of a positive electrode and a negative electrode may be avoided within a range of the average diameter of pores of 1 μm or less, which is thus preferred, but is not limited thereto.

The high heat-resistant porous polymer matrix may have a porosity of 10 to 90%, and more preferably 20 to 90%. Within the range, ion conductivity is excellent and mechanical strength is excellent, but the present invention is not limited thereto.

[Physical Properties of Porous Composite Separator]

In an exemplary embodiment of the present invention, the porous composite separator may have a rate of thickness change according to the following Equation 1 of 70% or less, preferably 65% or less, and more preferably 60% or less. More specifically, the rate of thickness change may be 0 to 70%.

Rate of thickness change (%)=(total thickness of porous composite separator−thickness of porous support)/thickness of porous support×100. [Equation 1]

The rate of thickness change shows how the thickness of the porous composite separator is changed relative to the thickness of an initial porous support, after forming the high heat-resistant porous polymer matrix, and as the rate of thickness change is smaller, a thinner separator may be provided. The separator according to the present invention may achieve a physical property of the rate of thickness change of 70% or less, and thus, it was confirmed that a separator of a thin film may be provided. In addition, within the range, a separator which corresponds to a thin film separator requirement for increasing a battery capacity and has a rate of size change of 5% or less, and has a thermal shrinkage of less than 15% against an electrolyte solution, may be provided, which is thus preferred.

In addition, the porous composite separator of the present invention may have a thermal shrinkage of less than 15%, preferably less than 10%, and more preferably less than 5%, in each of transverse and longitudinal directions, the thermal shrinkage being calculated by measuring a change in a width and a length, after allowing the porous composite separator to stand in an oven at 250° for an hour. More specifically, the thermal shrinkage may be 0 to 15%. Within the range, heat generation due to an abnormal situation of a battery is prevented, generation of short circuit by contact of a negative electrode and a positive electrode may be prevented, and a risk of rapid heat generation and explosion may be lowered, which is thus preferred.

The thermal shrinkage may be calculated as follows:

Thermal shrinkage=(length before heat treatment−length after heat treatment)/(length before heat treatment)×100.

In addition, the porous composite separator may have a rate of size change of 5% or less, and more preferably 3% or less, in each of transverse and longitudinal directions, the rate of size change being measured by cutting the porous composite separator so that the separator has a certain area and immersing the separator in an electrolyte solution for a week. More specifically, the rate of size change may be 0 to 5%, and within the range, long-term storage is excellent, a rate of volume change of the separator is small, so that a risk due to swelling may be prevented, which is thus preferred. When the rate of volume change of the separator is large, that is, the separator is expanded, spacing between a negative electrode and a positive electrode is increased, so that internal resistance is increased to deteriorate battery performance, and an overall volume increase may increase pressure in a cell and cause a breakage risk, and thus, it is preferred that the rate of volume change is not more than 5%.

The rate of size change may be calculated as follows:

Rate of size change=(length after being immersed in electrolyte solution for a week−length before being immersed in electrolyte solution)/(length before being immersed in electrolyte solution)×100.

Here, the electrolyte solution may be a mixture in which ethylene carbonate, ethylmethyl carbonate, and diethyl carbonate are mixed at a volume ratio of 3:5:2.

In an exemplary embodiment of the present invention, it is preferred that 30% or more, preferably 50% or more, and more preferably 80% or more of the internal void volume of the porous support is occupied by the high heat-resistant porous polymer matrix. Within the range, the micrometer-sized void size of the porous support may be uniformly decreased, which is thus preferred, but is not limited thereto.

In an exemplary embodiment of the present invention, the porous composite separator may have a total thickness of 30 μm or less, preferably 20 μm or less, and more preferably 15 μm or less. More specifically, the porous composite separator may have a total thickness of 1 to 30 μm or less, and within the range, the porous composite separator has an appropriate thickness for being used as the separator for an electrochemical device, but is not limited thereto. In addition, the thickness of the porous support in the porous composite separator may be 22 μm or less, preferably 17 μm or less, and more preferably 12 μm or less, but is not limited thereto.

In an exemplary embodiment of the present invention, the porosity of the porous composite separator is determined by the high heat-resistant porous polymer matrix and the porous support, and the porosity may be 10 to 90%. More specifically, the porosity may be 20 to 90%. Within the range, ion conductivity is excellent and mechanical strength is excellent, but the present invention is not limited thereto.

[Method of Producing Porous Composite Separator]

The method of producing a porous composite separator of the present invention is described. First, a porous support formed of fibers is prepared. Specifically for example, the porous support may be formed of a nonwoven fabric, and a nonwoven fabric produced by a production method in the art is usually used, but more preferably, a nonwoven fabric produced by a wet method may be used. Specifically, the nonwoven fabric may be produced by dispersing cut fibers using a dispersing solvent and removing the dispersing solvent. In addition, the nonwoven fabric produced by the wet method is heated and pressed if necessary, so that fibers are fused and combined.

Next, a matrix composition in which a high heat-resistant polymer, a phase separating agent incompatible with the high heat-resistant polymer, and a solvent compatible with both the phase separating agent and the high heat-resistant polymer are mixed is applied to the porous support so that the composition is impregnated in the porous support.

A method of applying the matrix composition may be dip coating, knife coating, roller coating, air knife coating, spray coating, brush coating, calender coating, slot die coating, and the like, but is not limited thereto.

Here, as described above, as the phase separating agent, a material which is incompatible with the high heat-resistant polymer, that is, is not mixed with the high heat-resistant polymer and dissolved in the solvent but has a different boiling point from the solvent, and more preferably, a material has a higher boiling point than the solvent may be used.

Next step is removing the solvent by heating to induce phase separation of the phase separating agent and the high heat-resistant polymer, wherein the heating may be performed in a temperature range of a melting temperature of the high heat-resistant polymer or lower and higher than a boiling point of the solvent. More specifically, the temperature range may be 100 to 150° C., but is not limited thereto.

Next, the phase separating agent is removed to form a high heat-resistant porous polymer matrix. A method of removing the phase separating agent may be thermal decomposition or evaporation by heating, wherein the heating temperature may be a temperature range of a melting temperature of the high heat-resistant polymer or lower and a boiling point of the phase separating agent or higher. More specifically, the temperature range may be 160 to 300°, but is not limited thereto. Otherwise, the phase separating agent may be removed by washing, and in this case, it may be removed by immersion in or washing with a solution which has no compatibility with the high heat-resistant polymer or may dissolve and remove only the phase separating agent. Otherwise, the phase separating agent may be removed and then the solvent may be removed by immersion in an exchange solution having compatibility with the phase separating agent and the solvent.

Hereinafter, the present invention will be described in more detail with reference to the Examples and Comparative Examples. However, the following Examples and Comparative Examples are only an example for describing the present invention in detail, and do not limit the present invention in any way.

Hereinafter, the physical properties were measured as follows:

1. Thermal Shrinkage

A produced composite separator was cut into a size of a width of 10 cm and a length of 10 cm, interposed between two glass plates, and allowed to stand in an oven at 250° C. for an hour, and then a change in width and length was measured and the thermal shrinkage was evaluated.

Thermal shrinkage=(length before heat treatment−length after heat treatment)/(length before heat treatment)×100

2. Rate of Size Change in Electrolyte Solution

A produced composite separator was cut into a size of a width of 10 cm and a length of 10 cm and immersed in an electrolyte solution for a week, and a change in width and length was measured and the rate of size change was measured. Here, as the electrolyte solution, ethylene carbonate, ethylmethyl carbonate, and diethyl carbonate at a volume ratio of 3:5:2 were mixed and used.

Rate of size change=(length after being immersed in electrolyte solution for a week−length before being immersed in electrolyte solution)/(length before being immersed in electrolyte solution)×100

3. Void Size

The surface of the produced composite separator was observed with a scanning electron microscope to obtain an image, from which the size was measured.

In addition, the void size was obtained using CFP-1500-AEL model available from PMI, which is a capillary flow porometer.

4. Porosity

A separator was cut into a size of a width of 10 cm and a length of 10 cm, the weight and the thickness were measured to calculate the density, and the porosity was calculated by the following equation using the density of the material:

Density of separator=(weight of separator)/(Volume of separator)=(weight of separator)/(10 cm×10 cm×(thickness of separator)),

Porosity=(density of material density of separator)/(density of material)×100.

5. Gurley Permeability

Gas permeability of the separator was measured according to JIS P8117 standard using Densometer available from Toyoseiki. The time that it takes for 100 cc of air to pass an area of 1 in² of the separator was recorded in seconds and compared.

### Example 1

A polyethylene terephthalate nonwoven fabric having a thickness of 15 μm and a Gurley permeability of 1 sec/100 cc air was prepared.

8.5 g of N-methyl-2-pyrrolidone and 1.5 g of tetraethylene glycol dimethyl ether were mixed, and polyamideimide was dissolved therein to prepare a coating solution having a solid content of 10 wt %.

A polyethylene terephthalate film was used as a coating support, and the polyethylene terephthalate nonwoven fabric prepared was placed thereon. The coating solution was applied to the nonwoven fabric prepared using a bar coater, the nonwoven fabric was dried at 130° C. for 10 minutes to remove N-methylpyrrolidone which is a solvent having a lower boiling point, phase separation between the remaining tetraethylene glycol dimethyl ether and polyamideimide was performed, the temperature was raised to 140° C., and the nonwoven fabric was further dried for 10 minutes to finally remove tetraethylene glycol dimethyl ether, thereby producing a nonwoven fabric impregnated with porous polyamideimide. Thereafter, the nonwoven fabric impregnated with polyamideimide was peeled off from the support.

The total thickness was 22 μm, and the Gurley permeability was 80 sec/100 cc air.

The physical properties were measured, and are shown in the following Table 1.

### Example 2

A polyethylene terephthalate nonwoven fabric having a thickness of 15 μm and a Gurley permeability of 1 sec/100 cc air was prepared.

A polyparaphenylene benzobisoxazole fiber was added to a solution in which methanesulfonic acid and trifluoroacetic acid were mixed at a volume ratio of 1:3 to prepare a solution having a solid content of 0.08 wt %.

A glass plate was used as a coating support, and the polyester nonwoven fabric prepared was fixed thereon. A coating solution was applied to the prepared nonwoven fabric using a bar coater, and the glass plate which is the coating support with the coating solution was immersed in a container containing isopropyl alcohol. After 10 minutes, the glass plate was taken out and washed with distilled water to remove remaining acid and isopropyl alcohol. The impregnated polyester nonwoven fabric was separated from the glass plate, fixed to a metal frame, and dried with hot air at 80° C., thereby producing a nonwoven fabric impregnated with a porous polymer. The final thickness was 23 μm and the Gurley permeability was 30 sec/100 cc air.

### Comparative Example 1

A polyamideimide porous film was produced in the same manner as in Example 1, except that the polyethylene terephthalate nonwoven fabric was not used.

The total thickness was 25 μm, and the Gurley permeability was 101 sec/100 cc air. The thermal shrinkage was shown to be similar to the value when the nonwoven fabric was not used, but the rate of size change measured after being immersed in an electrolyte solution for a week was higher in both transverse and longitudinal directions as compared with the Example, and when applied as a battery separator, it is expected that problems such as a size change inside and wrinkle occurrence therefrom may arise when applied as a battery separator.

### Comparative Example 2

A cellulose nonwoven fabric having a thickness of 14 μm and a Gurley permeability of 8 sec/100 cc air was prepared.

6 g of polyethylene glycol (number average molecular weight of 6,000), 1.68 g of hydrophobic fumed silica particles having a specific surface area of 90 to 130 m²/g and an average particle size of 16 nm, and 9 g of N-methylpyrrolidone were mixed to prepare a uniform solution, and 60 g of polyamideimide having a solid content of 14 wt % was further mixed therewith to prepare a coating solution.

A PET film was used as a coating support, and the cellulose nonwoven fabric prepared was placed thereon. The prepared cellulose nonwoven fabric was applied with the coating solution using a bar coater and dried at 120° C. for 30 minutes, and the coated cellulose nonwoven fabric was peeled off from the support and washed with distilled water. Thereafter, the cellulose nonwoven fabric was fixed to a metal frame and dried at 200° C. for 30 minutes to obtain a final film.

After coating the final thickness was 36 μm and the Gurley permeability was 725 sec/100 cc air. The rate of size change in an electrolyte solution was 2% and 1%, respectively in width and length.

When coating was performed on a nonwoven fabric, a heat resistance characteristic and the like were excellent, but the coating solution formed a porous layer in the form of forming a separate film outside the nonwoven fabric without being impregnated into the inside, and thus, the thickness of the final film was large, and in the case of the cellulose nonwoven fabric layer, a several micrometer pore size was maintained as it was. Besides, a peeling off phenomenon was observed between the nonwoven fabric and the coating layer in a portion of the film.

TABLE 1

| | | Ex- | Ex- | Com- | Com- |
|---|---|---|---|---|---|
| | | ample | ample | parative | parative |
| | | 1 | 2 | Example 1 | Example 2 |
| Thermal | Transverse | 3.5 | 0 | 3 | 1 |
| shrinkage | Longitudinal | 4.5 | 0 | 4 | 2 |
| (%) | | | | | |
| Rate of size | Transverse | 2.5 | 1.1 | 7 | 2 |
| change (%) | Longitudinal | 1.5 | 1.3 | 6 | 1 |

| | | | | |
|---|---|---|---|---|
| Volume (%) occupied by | 42 | 38 | — | 0 |
| high heat-resistant porous | | | | |
| polymer matrix | | | | |
| Nonwoven fabric | 15 | 15 | — | 14 |
| thickness (μm) | | | | |
| Total thickness (μm) | 22 | 23 | 25 | 36 |
| Ratio (%) of nonwoven | 68 | 65 | — | 39 |
| fabric thickness relative | | | | |
| to total thickness | | | | |
| Rate of thickness change | 46.6 | 53.3 | — | 157.1 |
| (%) | | | | |
| Average diameter (nm) | 188 | 30 | 188 | 180 |
| of pores in high heat- | | | | |
| resistant porous polymer | | | | |
| matrix | | | | |
| Porosity (%) of high | 58 | 50 | 58 | 45.5 |
| heat-resistant porous | | | | |
| polymer matrix | | | | |
| Permeability (Gurley) | 80 | 30 | 110 | 725 |

As seen from the above Table 1, it was found that in Examples 1 and 2 of the present invention, the rate of thickness change was 46.6% and 53.3%, respectively, which satisfies the physical property of 70% or less, and the separators of a thin film having the total thickness of 22 μm and 23 μm were produced.

In addition, as a result of measuring the size of pores in the high heat-resistant porous polymer matrix, it was confirmed that nano-sized pores of 188 nm and 30 nm were formed.

That is, it was confirmed that in the present invention, the high heat-resistant resin was permeated into the pores of the porous support and nano-sized pores were formed in the matrix formed of the high heat-resistant resin.

Accordingly, since the separator according to the present invention has a smaller rate of thickness change than that of Comparative Example 2, more separator layers may be formed in the same volume, and a battery capacity, durability and heat resistance may be further improved.

Comparative Example 1 has a configuration in which only a high heat-resistant resin matrix was formed without a nonwoven fabric, and the thermal shrinkage characteristic was similar to that of Example 1, but the rate of size change was more than 5% when being impregnated with an electrolyte solution, and it was found that matrix was swelled in the electrolyte solution.

In Comparative Example 2, the high heat-resistant resin was coated on a nonwoven fabric, and the thermal shrinkage and the rate of size change after being impregnated with an electrolyte solution were similar to the physical properties of the Examples, but the permeability was not good, and thus, it was found that the characteristics as the separator was not good. In addition, thinning was impossible and a partial peeling off phenomenon was observed, and thus, it was found that the coating form was not good as compared with the Examples.

1. A porous composite separator comprising: a porous support formed of fibers and a high heat-resistant porous polymer matrix filling space between the fibers,
wherein a rate of thickness change according to the following Equation 1 is 70% or less:
Rate of thickness change (%)=(total thickness of porous composite separator−thickness of porous support)/thickness of porous support×100. [Equation 1]

2. The porous composite separator of claim 1, wherein the porous composite separator has a thermal shrinkage of less than 15% in each of transverse and longitudinal directions, the thermal shrinkage being measured after allowing the porous composite separator to stand in an oven at 250° C. for an hour.

3. The porous composite separator of claim 3, wherein the thermal shrinkage is less than 5%.

4. The porous composite separator of claim 1, wherein the porous composite separator has a rate of size change of 5% or less in each of transverse and longitudinal directions, the rate of size change being measured after immersing the porous composite separator in an electrolyte solution for a week.

5. The porous composite separator of claim 4, wherein the rate of size change is 3% or less in each of transverse and longitudinal directions.

6. The porous composite separator of claim 1, wherein the high heat-resistant porous polymer matrix has pores formed by a phase separating agent incompatible with a high heat-resistant polymer.

7. The porous composite separator of claim 1, wherein 30% or more of a void volume inside the porous support is occupied by the high heat-resistant porous polymer matrix.

8. The porous composite separator of claim 1, wherein a material of a fiber forming the porous support is selected from any one, a blend of two or more, or a copolymer of two or more selected from the group consisting of polyester, polyimide, polyamide, polysulfone, polyvinylidene fluoride, polyacrylonitrile, and polyolefin.

9. The porous composite separator of claim 1, wherein the high heat-resistant porous polymer matrix has a porosity of 10 to 90%.

10. The porous composite separator of claim 1, wherein an average diameter of pores inside the high heat-resistant porous polymer matrix is 1 μm or less.

11. The porous composite separator of claim 1, wherein the high heat-resistant porous polymer matrix is formed of any one or two or more high heat-resistant polymers selected from the group consisting of polyimide, polyamide, aramid, polyamideimide, and polyparaphenylbenzobisoxazole.

12. An electrochemical device comprising a positive electrode, a negative electrode, and a separator interposed between the positive electrode and the negative electrode, wherein the separator includes the porous composite separator of claim 1.

13. A method of producing a porous composite separator, the method comprising:
a) impregnating a porous support formed of fibers with a matrix composition in which a high heat-resistant polymer, a phase separating agent incompatible with the high heat-resistant polymer, and a solvent compatible with both the phase separating agent and the high heat-resistant polymer are mixed;
b) removing the solvent to induce phase separation of the phase separating agent and the high heat-resistant polymer; and
c) removing the phase separating agent to form a high heat-resistant porous polymer matrix.

14. The method of producing a porous composite separator of claim 13, wherein the solvent in step b) is removed by heating, and the phase separating agent in step c) is removed by heating or washing.

15. The method of producing a porous composite separator of claim 13, wherein in step b) and step c), the phase separating agent and the solvent are removed by immersion in an exchange solution having compatibility with the phase separating agent and the solvent.

16. The method of producing a porous composite separator of claim 13, wherein a method of impregnating the matrix composition in) is selected from the group consisting of dip coating, knife coating, roller coating, air knife coating, spray coating, brush coating, calender coating, and slot die coating.
